(19) United States
(12) Patent Application Publication
(10) Pub. No.: US 2026/0188904 A1
(43) Pub. Date: Jul. 2, 2026

(54) RADIATOR MODULE AND ANTENNA DEVICE FOR PERFORMING BROADSIDE RADIATION AND END-FIRE RADIATION

(71) Applicant: POSTECH RESEARCH AND BUSINESS DEVELOPMENT FOUNDATION, Pohang-si (KR)

(72) Inventors: Won Bin HONG, Seoul (KR); Jeong Hyo LEE, Pohang-si (KR)

(73) Assignee: POSTECH RESEARCH AND BUSINESS DEVELOPMENT FOUNDATION, Pohang-si (KR)

(21) Appl. No.: 19/326,310

(22) Filed: Sep. 11, 2025

(30) Foreign Application Priority Data
Dec. 30, 2024 (KR) 10-2024-0200671

(51) Int. Cl. H01Q 9/04; H01Q 21/06

(52) U.S. Cl. CPC H01Q 9/0407; H01Q 21/067

(57) ABSTRACT

Provided is a radiator module for performing broadside radiation and end-fire radiation. The radiator module includes a dielectric layer, a ground layer disposed on the dielectric layer and having a common ground plane for both the broadside radiation and the end-fire radiation, a patch radiator disposed on the ground layer so as to be spaced apart from the ground layer by a predetermined length, and at least one port disposed between the common ground plane and the patch radiator.

### CROSS-REFERENCE TO RELATED APPLICATION

This application claims the benefit of and priority to Korean Patent Application No. 10-2024-0200671, filed on Dec. 30, 2024, the entire disclosure(s) of which is hereby incorporated herein by reference in its entirety.

### TECHNICAL FIELD

The present disclosure relates to wireless communication, and more particularly, to a radiator module and an antenna device for performing broadside radiation and end-fire radiation.

### BACKGROUND

Wireless communication technologies for transmitting and receiving information are continuously developing. Among them, an antenna device is required to transmit or receive a signal for wireless communication, and antenna devices in various forms and of various types have been developed to achieve higher performance. Recently, technologies, such as an MIMO antenna, have been developed to overcome performance limitations that are difficult to surpass with a single antenna. Additionally, a beamforming technology for controlling radiation directions of signals to maximize a strength of the signals transmitted and received between a base station and a terminal has been developed.

In particular, recent wireless communication technologies such as, for example, 3GPP 5G have begun to use frequency in a millimeter wave (mmWave) band. In a millimeter wave band wireless channel environment, a beamforming technology using a phased array antenna is being applied more importantly to solve a problem that signal attenuation may occur because of characteristics of free space path loss and diffraction reduction. Such a beamforming technology is required at both the base station and the terminal, and in particular, it is essential to secure wide coverage and overcome radio wave loss in a mobile wireless channel environment.

However, because the phased array antenna for the beamforming includes a plurality of radiators, an efficient mounting method for the wireless terminal should be considered. For example, an antenna-in-package (AiP) technology that combines the antenna with an RFIC is attracting attention as a solution for the terminal mounting of the phased array antenna. To minimize a shadow area and improve the beamforming coverage, a plurality of AiPs are required to be disposed in the terminal. In this regard, a problem that a mounting space becomes narrow may occur in consideration of electric coexistence with other existing antennas and/or coexistence with mechanical components.

### SUMMARY

An object of the present disclosure for solving the above-described problems is to provide a radiator module capable of minimizing structural complexity and achieving a miniaturized structure using a patch radiator and a common ground plane that may operate together as a ground plane for broadside radiation and a ground plane for performing end-fire radiation, thereby maximizing spatial efficiency and also improving beamforming coverage.

Another object of the present disclosure for solving the above-described problems is to provide an antenna device capable of performing beamforming in a broadside direction and beamforming in an end-fire direction by including a plurality of radiator modules, each including a patch radiator and a common ground plane capable of operating together as a ground plane for broadside radiation and a ground plane for performing end-fire radiation.

However, the objects of the present disclosure may not be limited thereto, and may be variously expanded within a range not departing from the spirit and scope of the present disclosure.

To achieve the above-described objects, an aspect of the present disclosure provides a radiator module for performing broadside radiation and end-fire radiation including a dielectric layer, a ground layer disposed on the dielectric layer and having a common ground plane for both the broadside radiation and the end-fire radiation, a patch radiator disposed on the ground layer so as to be spaced apart from the ground layer by a predetermined length, and at least one port disposed between the common ground plane and the patch radiator.

In one implementation, the common ground plane may include a first notch area defined in at least a portion of an edge of the common ground plane in a first direction, and the first notch area may include an area extending from a location of the common ground plane corresponding to an edge of the patch radiator in the first direction to the edge of the common ground plane in the first direction.

In one implementation, the patch radiator may perform the end-fire radiation in the first direction as the first notch area is included.

In one implementation, a signal transmitted and received via the end-fire radiation may be a vertically polarized signal.

In one implementation, the common ground plane may include a second notch area defined in at least a portion of an edge of the common ground plane in a second direction opposite to the first direction, and the second notch area may include an area extending from a location of the common ground plane corresponding to an edge of the patch radiator in the second direction to the edge of the common ground plane in the second direction.

In one implementation, the patch radiator may perform the end-fire radiation in the second direction as the second notch area is included.

In one implementation, the radiator module may further include a reflector disposed to be directed in the second direction of the common ground plane and extending in a height direction of the radiator module.

In one implementation, the reflector may reflect a second directional end-fire radiation signal based on the second notch area.

In one implementation, the common ground plane may further include a first broadside ground area defined in an area extending from a location of the common ground plane corresponding to an edge of the patch radiator in a third direction to an edge of the common ground plane in the third direction.

In one implementation, the common ground plane may further include a second broadside ground area defined in an area extending from a location of the common ground plane corresponding to an edge of the patch radiator in a fourth direction opposite to the third direction to an edge of the common ground plane in the fourth direction.

In one implementation, the common ground plane may allow the patch radiator to perform both the broadside radiation and the end-fire radiation as the first notch area, the second notch area, the first broadside ground area, and the second broadside ground area are included.

In one implementation, the at least one port may include at least one vertical probe port.

In one implementation, the at least one port may include a broadside port for the broadside radiation, and an end-fire port for the end-fire radiation.

In one implementation, the broadside port may be disposed to be spaced apart from a center line between an edge in a first direction and an edge in a second direction of the common ground plane, and may be disposed at a location corresponding to a center line between an edge in a third direction and an edge in a fourth direction of the common ground plane.

In one implementation, the end-fire port may be disposed at a location corresponding to a center line between an edge in a first direction and an edge in a second direction of the common ground plane, and may be disposed to be spaced apart from a center line between an edge in a third direction and an edge in a fourth direction of the common ground plane.

In one implementation, the edge of the common ground plane in the first direction and an edge of the dielectric layer in the first direction may coincide with each other.

In one implementation, an edge of the dielectric layer in a second direction opposite to the first direction may be disposed to be spaced apart in the second direction from an edge of the common ground plane in the second direction.

To achieve the above-described objects, another aspect of the present disclosure provides an antenna device for performing broadside radiation and end-fire radiation including a radiator array including a plurality of radiator modules, and a control circuit that applies signals to the plurality of radiator modules, wherein each of the plurality of radiator modules includes a dielectric layer, a ground layer disposed on the dielectric layer and having a common ground plane for both the broadside radiation and the end-fire radiation, a patch radiator disposed on the ground layer so as to be spaced apart from the ground layer by a predetermined length, and at least one port disposed between the common ground plane and the patch radiator.

In one implementation, the control circuit may perform broadside directional beamforming by controlling each of the plurality of radiator modules to perform the broadside radiation.

In one implementation, the control circuit may perform end-fire directional beamforming by controlling each of the plurality of radiator modules to perform the end-fire radiation.

The disclosed technology may have following effects. However, because it does not mean that a specific embodiment should include all of the following effects or only the following effects, it should not be understood that the scope of the rights of the disclosed technology is limited thereto.

The radiator that performs the broadside radiation and the end-fire radiation according to an embodiment of the present disclosure described above may minimize the structural complexity and achieve the miniaturized structure using the patch radiator and the common ground plane that may operate together as the ground plane for the broadside radiation and the ground plane for performing the end-fire radiation, thereby maximizing the spatial efficiency and also improving the beamforming coverage.

Further, the antenna device that performs the broadside radiation and the end-fire radiation according to another embodiment of the present disclosure described above may perform the beamforming in the broadside direction and the beamforming in the end-fire direction by including the plurality of radiator modules, each including the patch radiator and the common ground plane capable of operating together as the ground plane for the broadside radiation and the ground plane for performing the end-fire radiation.

### BRIEF DESCRIPTION OF THE DRAWINGS

FIG. 1 is a perspective view of a radiator module that performs broadside radiation and end-fire radiation according to an embodiment of the present disclosure.

FIG. 2 is a top view of a radiator module in FIG. 1.

FIG. 3 illustrates a design of a ground plane for performing end-fire radiation according to an aspect of the present disclosure.

FIG. 4 illustrates a gain measured at a frequency of 28 GHz based on a ground plane design in FIG. 3.

FIG. 5 illustrates an electric field distribution at a frequency of 28 GHz based on a ground plane design in FIG. 3.

FIG. 6 exemplarily illustrates a common ground plane according to an aspect of the present disclosure.

FIG. 7 illustrates reflection coefficients measured based on a common ground plane in FIG. 6.

FIG. 8 illustrates a gain measured at a frequency of 28 GHz for broadside radiation of a radiator module according to an embodiment of the present disclosure.

FIG. 9 illustrates an electric field distribution at a frequency of 28 GHz for broadside radiation of a radiator module according to an embodiment of the present disclosure.

FIG. 10 illustrates a change in performance of end-fire radiation based on dielectric cutting according to an embodiment of the present disclosure.

FIG. 11 is a perspective view of an antenna device that performs broadside radiation and end-fire radiation according to an embodiment of the present disclosure.

FIG. 12 is a top view of an antenna device in FIG. 11.

FIG. 13 illustrates a beamforming performance in broadside radiation at a frequency of 28 GHz of an antenna device in FIG. 11.

FIG. 14 illustrates a beamforming performance in end-fire radiation at a frequency of 28 GHz of an antenna device in FIG. 11.

### DETAILED DESCRIPTION

Because the present disclosure may be variously changed and have various embodiments, specific embodiments will be illustrated in the drawings and described in detail.

However, this is not intended to limit the present disclosure to the specific embodiments, and it should be understood that the present disclosure includes all changes, equivalents, and substitutes included in the spirit and technical scope of the present disclosure.

Terms such as first, second, and the like may be used to describe various components, but the components should not be limited by the terms. The terms are used only for the purpose of distinguishing one component from another component. For example, without departing from the scope of the present disclosure, a first component may be referred to as a second component, and similarly, a second component may also be referred to as a first component. The term and/or includes a combination of a plurality of related described items or any of the plurality of related described items.

When it is mentioned that a component is “connected” or “coupled” to another component, it should be understood that the component may be directly connected or coupled to said another component, but a further component may exist therebetween. On the other hand, when it is mentioned that a component is “directly connected” or “directly coupled” to another component, it should be understood that the further component does not exist therebetween.

The terms used herein are used only to describe the specific embodiments and are not intended to limit the present disclosure. A singular expression includes a plural expression, unless the context clearly dictates otherwise. In the present application, terms such as “include” or “have” are intended to designate that features, numbers, steps, operations, components, parts, or combinations thereof described herein exist, and it should be understood that the possibility of the presence or addition of one or more other features, numbers, steps, operations, components, parts, or combinations thereof is not excluded in advance.

Unless otherwise defined, all terms used herein, including technical or scientific terms, have the same meanings as those generally understood by those of ordinary skill in the art to which the present disclosure pertains. Terms such as those defined in commonly used dictionaries should be interpreted as having meanings consistent with contextual meanings of the related art, and are not interpreted in an ideal or excessively formal sense unless explicitly defined in the present application.

Hereinafter, preferred embodiments of the present disclosure will be described in more detail with reference to the accompanying drawings. In the description of the present disclosure, to facilitate overall understanding, the same reference numerals are used for the same components in the drawings, and redundant descriptions of the same components will be omitted.

As described above, to implement the high-speed data transmission rate and the low latency communication, mmWave wireless communication is in the spotlight. As a solution to a high free space loss of the mmWave wireless communication, an importance of the beamforming technology using the phased array antenna is further highlighted. Here, a beamforming technology implemented only in a single direction generates a radio wave shadow area, and to solve such a problem, simultaneous beamforming implementation in multiple directions is essential.

In this regard, as described above, because the phased array antenna for the beamforming includes the plurality of radiators, an efficient mounting method for the wireless terminal should be considered. For example, the antenna-in-package (AiP) technology that combines the antenna with the RFIC is attracting attention as the solution for the terminal mounting of the phased array antenna. To minimize the shadow area and improve the beamforming coverage, the plurality of AiPs are required to be disposed in the terminal. In this regard, the problem that the mounting space becomes narrow may occur in consideration of the electric coexistence with other existing antennas and/or the coexistence with the mechanical components. For example, because the mobile terminal includes various antennas such as a Wi-Fi antenna, a 3G or 4G antenna, and a GPS antenna in addition to a plurality of 5G antennas, and also includes components such as a camera and a battery, a method for efficiently mounting the plurality of AiPs in the limited space is required.

In an existing millimeter wave AiP technology, a patch antenna has mainly been used for broadside radiation. However, in consideration of the coverage of the terminal, the patch antenna only supports a beam for one direction, which may cause a problem of occurrence of the shadow area. Further, when the patch antenna is disposed on a side surface of the terminal, an overall thickness (profile) may increase. In addition, an overall process difficulty may increase.

In addition, to perform the end-fire radiation in the existing millimeter wave AiP technology, for example, a planar slot antenna, a Yagi-Uda antenna, or a cavity back slot antenna has been used, but because such an antenna only supports the beam in one direction similarly, the occurrence of the shadow area may be caused.

In addition, in a technology of supporting multi-directional beams for improving the beam coverage, a plurality of phased array antennas or a pattern reconstruction antenna using an active element such as a pin diode to vary an antenna mode have been used. However, when the plurality of antennas are used, a space occupied by the plurality of antennas is increased, which is disadvantageous in terms of the terminal mounting. Further, when the active element is used, packaging with the RFIC becomes difficult and process complexity is increased because of an additional DC bias controller.

The present disclosure is to solve such problems. A radiator module that performs broadside radiation and end-fire radiation according to an embodiment of the present disclosure may include a common ground plane capable of operating as a ground plane for the broadside radiation and an end-fire ground plane, thereby performing both the broadside radiation and the end-fire radiation using one ground plane and one patch. Accordingly, structural complexity may be minimized and a miniaturized structure may be achieved, thereby maximizing spatial efficiency and also improving the beamforming coverage. The common ground plane may reflect a trade-off between design of the ground plane for the broadside radiation and design of the ground plane for the end-fire radiation, and may also be referred to as a ‘complementary ground plane’ in the present disclosure.

In addition, an antenna device that performs the broadside radiation and the end-fire radiation according to another embodiment of the present disclosure may include a radiator array composed of the radiator module capable of performing both the broadside radiation and the end-fire radiation with the one ground plane and the patch radiator, thereby implementing both beamforming for a signal in a broadside radiation direction and beamforming for an end-fire radiation direction based on the one radiator array.

That is, because a wide beam coverage and a high gain may be realized via the implementation of the beamforming in the plurality of directions using only one phased array antenna without using the active element, it may be very usefully used in the mmWave wireless communication. More specifically, because RF integrated circuits respectively required for single-directional antennas such as existing broadside and the end-fire antennas may be implemented as one integrated AiP, the number of AiPs required in the terminal may be reduced, which is advantageous in terms of cost efficiency.

### Radiator Module

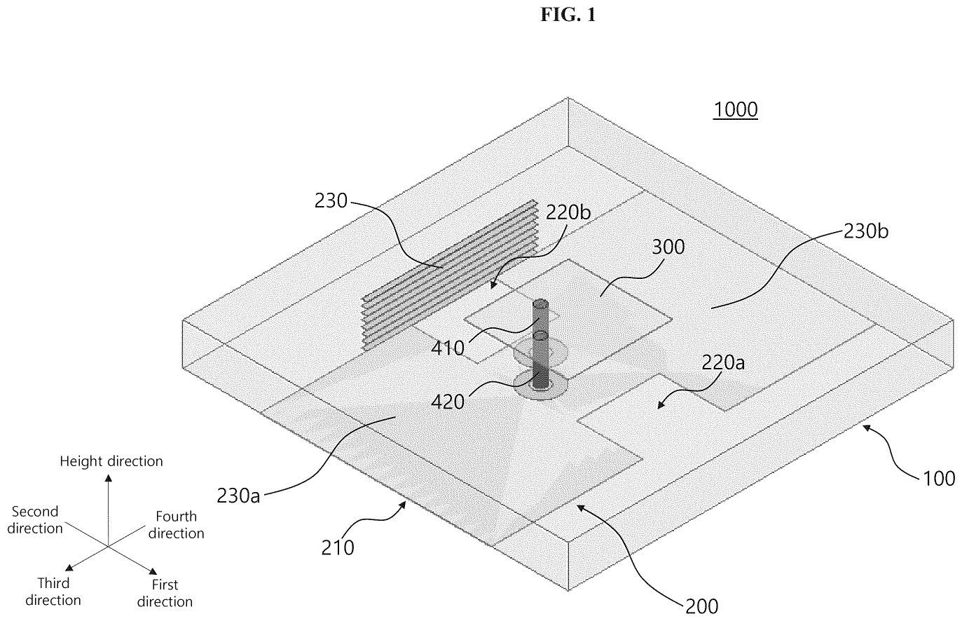

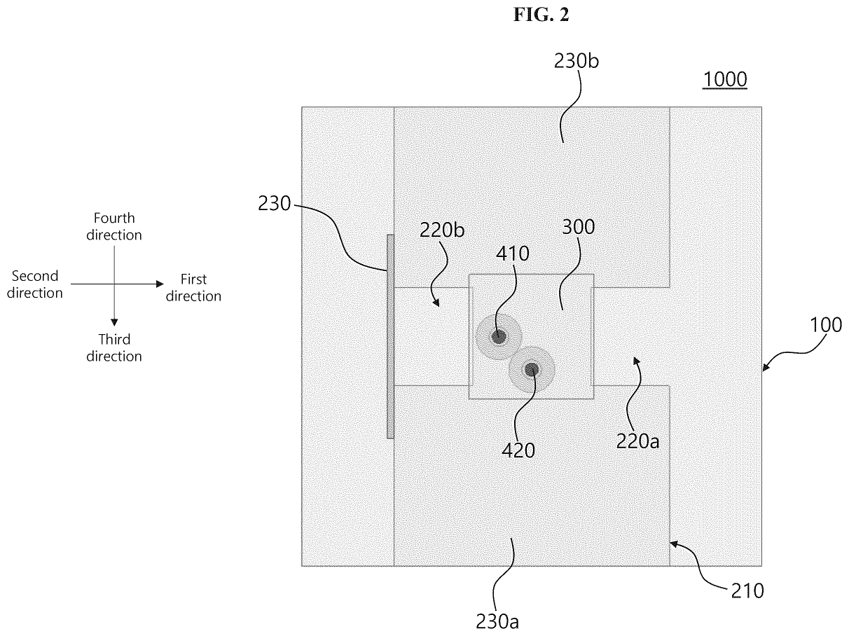

FIG. 1 is a perspective view of a radiator module that performs broadside radiation and end-fire radiation according to an embodiment of the present disclosure, and FIG. 2 is a top view of a radiator module in FIG. 1. Hereinafter, the radiator module that performs the broadside radiation and the end-fire radiation according to an embodiment of the present disclosure will be described in more detail with reference to FIGS. 1 and 2.

Hereinafter, in the present disclosure, a front side of the radiator module that performs the broadside radiation and the end-fire radiation may be directed in a first direction, a rear side of the radiator module may be directed in a second direction, and the first and second directions may also be collectively referred to as an ‘end-fire radiation front and rear direction’. In addition, based on the front side of the radiator module, a left side thereof may be directed in a fourth direction, a right side thereof may be directed in a third direction, and the third and fourth directions may also be collectively referred to as a “width direction”. The height direction of the radiator module may be referred to as a “broadside radiation direction”. However, it should be noted that this is merely an example for convenience of description, and the technical idea of the present disclosure is not limited thereto.

The radiator module that performs the broadside radiation and the end-fire radiation according to an embodiment of the present disclosure may be composed of, for example, the patch radiator and the complementary ground plane. The complementary ground plane may also operate as the broadside radiation ground plane for allowing the patch radiator to perform the broadside radiation, and may also operate as the end-fire radiation ground plane for allowing the patch radiator to perform the end-fire radiation. The complementary ground plane may be designed to serve as the ground plane for the broadside radiation and the end-fire radiation at a reasonable level even when it does not provide optimal performance for performing either the broadside radiation or the end-fire radiation.

In addition, according to an aspect, both the broadside radiation and the end-fire radiation may be performed at 28 GHz with only one patch antenna, via at least one port. A change in the radiation direction depending on an input port may be an effect achieved by the complementary ground plane.

Hereinafter, the radiator module that performs the broadside radiation and the end-fire radiation according to an aspect of the present disclosure will be described in more detail with reference to FIGS. 1 to 2. As illustrated in FIGS. 1 and 2, a radiator module 1000 that performs the broadside radiation and the end-fire radiation according to an embodiment of the present disclosure may include a dielectric layer 100, a ground layer 200, a patch radiator 300, and at least one port 410 and 420.

The dielectric layer 100 may be a base layer of the radiator module according to an aspect. In an exemplary implementation, when the radiator module according to an embodiment of the present disclosure is implemented based on an LTCC technique, the dielectric layer 100 may be made of a ceramic material, but the present disclosure may not be limited thereto. Further, it should be understood that any dielectric material may be applied as a material of the dielectric layer 100 according to embodiments of the present disclosure.

As illustrated in FIGS. 1 and 2, the ground layer 200 may be disposed on the dielectric layer 100. The ground layer 200 may be made of, for example, a metal material, and may be formed via, for example, a screen printing method using a silver (Ag) paste, but the present disclosure may not be limited thereto, and the ground layer may be formed via any manufacturing method. The ground layer 200 may include a common ground plane 210. The common ground plane 210 may serve as the ground plane for both the broadside radiation and the end-fire radiation. As described above, the common ground plane 210 may be referred to as the complementary ground plane, but it should be understood that the technical features of the present disclosure are not limited thereto.

As illustrated in FIGS. 1 and 2, the patch radiator 300 may be disposed on the ground layer 200 so as to be spaced apart from the ground layer 200 by a predetermined length. Although a quadrangular patch radiator is exemplarily illustrated in FIGS. 1 and 2, it should be understood that the technical idea of the present disclosure is not limited thereto.

The at least one port 410 and 420 may be disposed between the common ground plane 210 and the patch radiator 300 and provide an electrical connection between the common ground plane 210 and the patch radiator 300. Although FIGS. 1 and 2 illustrate that a port 410 for the broadside radiation and a port 420 for the end-fire radiation are separately equipped, according to another aspect, the broadside radiation or the end-fire radiation may be selectively performed via one port.

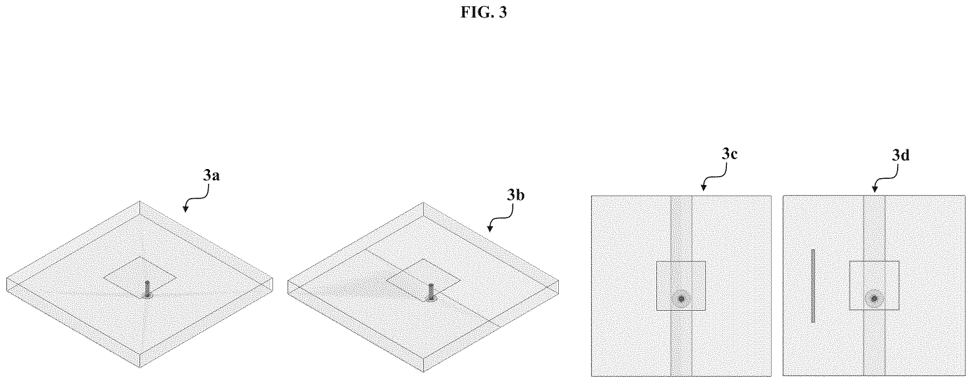

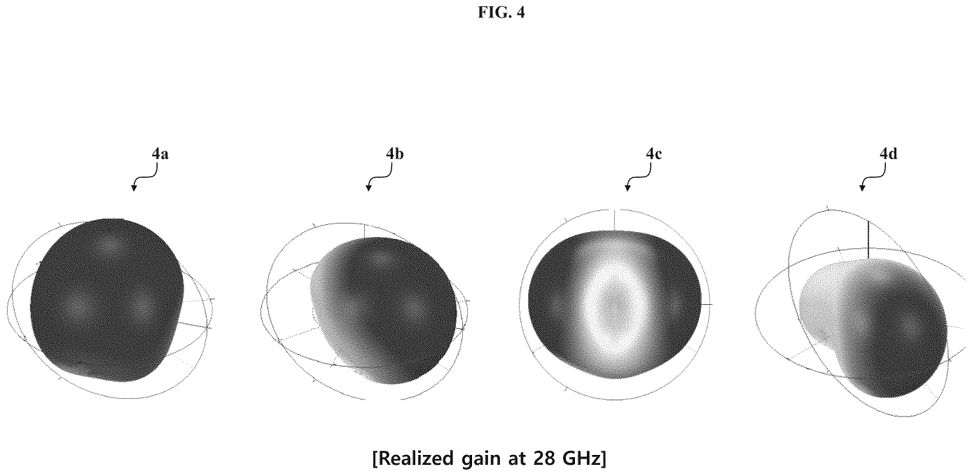

In this regard, FIG. 3 illustrates a design of a ground plane for performing end-fire radiation according to an aspect of the present disclosure, and FIG. 4 illustrates a gain measured at a frequency of 28 GHz based on a ground plane design in FIG. 3. The end-fire radiation of the radiator module according to embodiments of the present disclosure will be described in more detail with reference to FIGS. 3 to 4.

As illustrated in FIGS. 3 and 4, for example, when an entire area of a square patch radiator and a general ground layer is provided as the ground plane, the broadside radiation may be implemented (4a) using a basic resonance mode of (3a). For example, signal transmission and reception in a millimeter wave band may be achieved via 28 GHz resonance.

Here, according to an aspect, by cutting (3b) one side of the ground plane, for example, end-fire radiation with vertical polarization may be implemented (4b). For example, at one edge of the patch radiator, an electric field distribution toward the cut surface of the ground plane may be formed, and the end-fire radiation may be implemented by allowing the radiation to be performed in a direction perpendicular thereto.

Further, by further cutting (3c) both sides of the ground plane, for example, the end-fire radiation with the vertical polarization may be implemented (4c) in both directions. That is, the electric field distribution toward the respective cut surfaces of the ground plane may be formed at both edges of the radiator, and thus the radiation may be performed in a direction perpendicular thereto, so that the end-fire radiation may be implemented in both left and right directions in FIG. 3.

As shown again in FIG. 3, by placing (3d) a reflector at one side of the patch radiator, for example, at a left side of the patch radiator in FIG. 3, bi-directional end-fire radiation signals with the vertical polarization may be synthesized (28 GHz) with each other, so that end-fire radiation toward one side, for example, the left side in FIG. 3, may be implemented (4d).

In the past, it was very difficult to implement a vertically polarized end-fire radiation antenna from a thin dielectric material. The radiator module that performs the broadside radiation and the end-fire radiation according to an embodiment of the present disclosure may implement the end-fire radiation with the vertical polarization at a very thin thickness (e.g., 0.07λ) with the simple ground plane structure deformation such as the ground plane cutting. This may be the result of engineering design using an image theory of current. In addition, although the synthesis of the end-fire radiation using the existing reflector has been implemented in H-pol, the radiator module that performs the broadside radiation and the end-fire radiation according to an embodiment of the present disclosure may implement a new technology of synthesizing the radiation via the reflector after implementing the bi-directional V-pol end-fire radiation by cutting both sides of the ground plane.

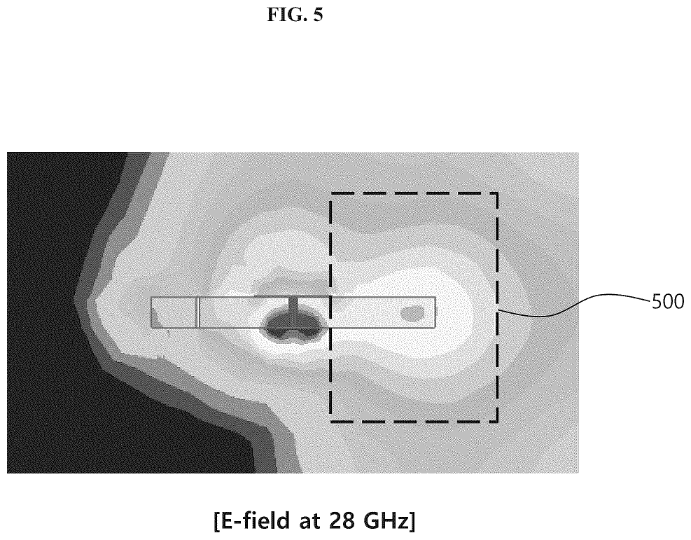

FIG. 5 illustrates an electric field distribution at a frequency of 28 GHz based on a ground plane design in FIG. 3. As illustrated in FIG. 5, based on the radiator module that performs the broadside radiation and the end-fire radiation according to an embodiment of the present disclosure, for example, it may be clearly seen that end-fire radiation 500 is implemented toward a right side in FIG. 5.

According to an aspect, in the radiator module that performs the broadside radiation and the end-fire radiation according to an embodiment of the present disclosure, to implement both the end-fire radiation and the broadside radiation using the one patch radiator 300 and the one common ground plane 210, the common ground plane 210 may perform both the function of the ground plane for the broadside radiation and the function of the ground plane for the end-fire radiation.

To this end, the design of the ground plane cutting described with reference to FIGS. 3 to 4 may be implemented in a form of, for example, a notch area defined in the ground plane.

More specifically, as illustrated in FIGS. 1, 2, or 6, according to an aspect of the present disclosure, the common ground plane 210 may include a first notch area 220a defined in at least a portion of a first directional edge of the common ground plane. For example, the first notch area 220a as such may include an area extending from a location of the common ground plane corresponding to a first directional edge of the patch radiator to the first directional edge of the common ground plane. That is, at least a portion of the common ground plane 210 corresponding to the first directional edge of the patch radiator 300 may have a cut surface and form a distribution of an electric field from the first directional edge of the patch radiator 300 toward the cut surface of the common ground plane 210. Here, it should be noted that the technical idea of the present disclosure is not limited to the first notch area being defined precisely from a point exactly coinciding with the location of the first directional edge of the patch radiator 300. Further, the first notch area may also be defined from a point spaced apart therefrom by a predetermined distance in the first direction or the second direction to the first directional edge of the common ground plane 210.

In addition, a width (a length in the third and fourth directions) of the first notch area 220a may correspond to, for example, a length of the first directional edge of the patch radiator 300, but may not be limited thereto. By way of non-limiting example, in an environment in which efficiency for the broadside radiation is increased and somewhat reduced efficiency for the end-fire radiation is tolerated, the width of the first notch area 220a may be smaller than the length of the first directional edge of the patch radiator 300.

According to an aspect, the patch radiator 300 may perform the end-fire radiation in the first direction by having the first notch area 220a in the common ground plane 210 as described above. According to an aspect, a signal transmitted and received via the end-fire radiation may be a vertically polarized signal, but may not be limited thereto.

As illustrated in FIGS. 1, 2, or 6, according to an aspect of the present disclosure, the common ground plane 210 may include a second notch area 220b defined in at least a portion of an edge of the common ground plane in the second direction (opposite to the first direction). For example, the second notch area 220b as such may include an area extending from a location of the common ground plane corresponding to a second directional edge of the patch radiator to the second directional edge of the common ground plane. That is, at least a portion of the common ground plane 210 corresponding to the second directional edge of the patch radiator 300 may have a cut surface and form a distribution of an electric field from the second directional edge of the patch radiator 300 toward the cut surface of the common ground plane 210. Here, it should be noted that the technical idea of the present disclosure is not limited to the second notch area being defined precisely at a point exactly coinciding with the location of the second directional edge of the patch radiator 300. Further, the second notch area may also be defined from a point spaced apart therefrom by a predetermined distance in the first direction or the second direction to the second directional edge of the common ground plane 210.

In addition, a width (a length in the third and fourth directions) of the second notch area 220b may correspond to, for example, a length of the second directional edge of the patch radiator 300, but may not be limited thereto. By way of non-limiting example, in the environment in which the efficiency for the broadside radiation is increased and the somewhat reduced efficiency for the end-fire radiation is tolerated, the width of the second notch area 220b may be smaller than the length of the second directional edge of the patch radiator 300.

In addition, according to an aspect, the width (the length in the third and fourth directions) of the first notch area 220a may correspond to, for example, the length of the first directional edge of the patch radiator 300, and the width (the length in the third and fourth directions) of the second notch area 220b may be smaller than, for example, the length of the second directional edge of the patch radiator 300, but the present disclosure may not be limited thereto. For example, with such a design, a front back ratio (FBR) improvement for the end-fire radiation may be achieved.

According to an aspect, the patch radiator 300 may perform the end-fire radiation in the second direction by having the second notch area 220b in the common ground plane 210 as described above. According to an aspect, the signal transmitted and received via the end-fire radiation may be the vertically polarized signal, but may not be limited thereto.

As illustrated in FIGS. 1 and 2, a reflector 230 extending in the height direction of the radiator module may be further disposed so as to be directed in the second direction. According to an aspect, the reflector 230 may reflect a second directional end-fire radiation signal based on the second notch area 220b. Accordingly, the front back ratio (FBR) for the end-fire radiation of the radiator module according to an embodiment of the present disclosure may be improved.

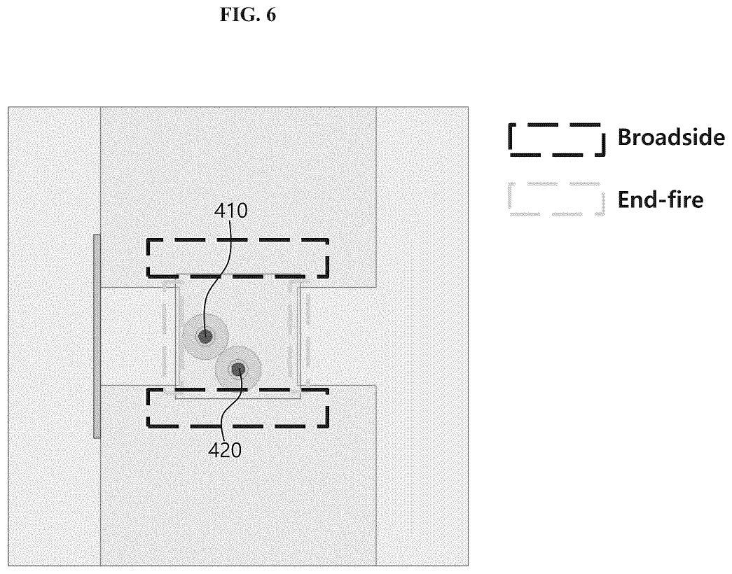

FIG. 6 exemplarily illustrates a common ground plane according to an aspect of the present disclosure. As illustrated in FIGS. 1 to 2, or FIG. 6, according to an aspect of the present disclosure, the common ground plane 210 may further include a first broadside ground area 230b defined in an area extending from a location of the common ground plane corresponding to a third directional edge of the patch radiator 300 to a third directional edge of the common ground plane 210. In addition, according to an aspect, the common ground plane 210 may further include a second broadside ground area 230a defined in an area extending from a location of the common ground plane corresponding to an edge in the fourth direction opposite to the third direction of the patch radiator 300 to a fourth directional edge of the common ground plane 210. That is, in applying the end-fire radiation implementation based on the ground plane cutting as illustrated in FIGS. 3 to 5 described above, by having the first notch area 220a and/or the second notch area 220b according to an aspect of the present disclosure, the broadside ground areas 230a and 230b that perform a ground function for the broadside radiation having an area equal to or greater than a predetermined area may be disposed in third directional area and fourth directional area of the common ground plane 210, respectively.

As illustrated in FIG. 6, for example, areas of the common ground plane 210 corresponding to the first and second directional edges of the patch radiator 300 may perform a grounding function for the end-fire radiation, and areas of the common ground plane 210 corresponding to the third and fourth directional edges of the patch radiator 300 may perform a grounding function for the broadside radiation.

In other words, according to an aspect of the present disclosure, the common ground plane 210 may allow the patch radiator 300 to perform both the broadside radiation and the end-fire radiation by having the first notch area 220a, the second notch area 220b, the first broadside ground area 230b, and the second broadside ground area 230a.

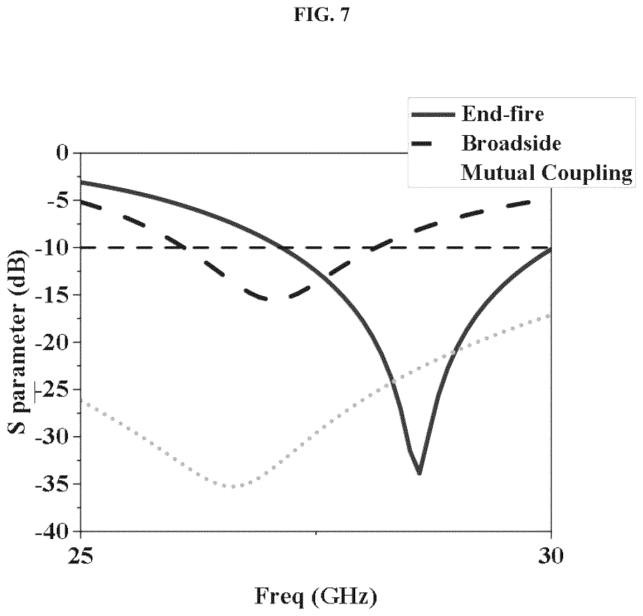

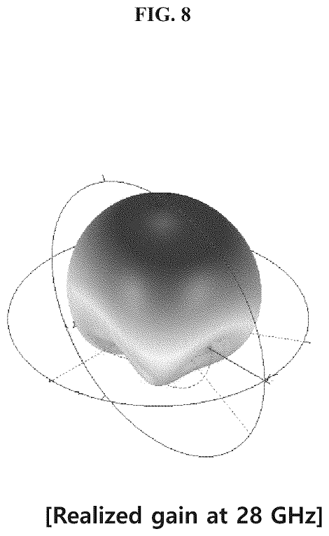

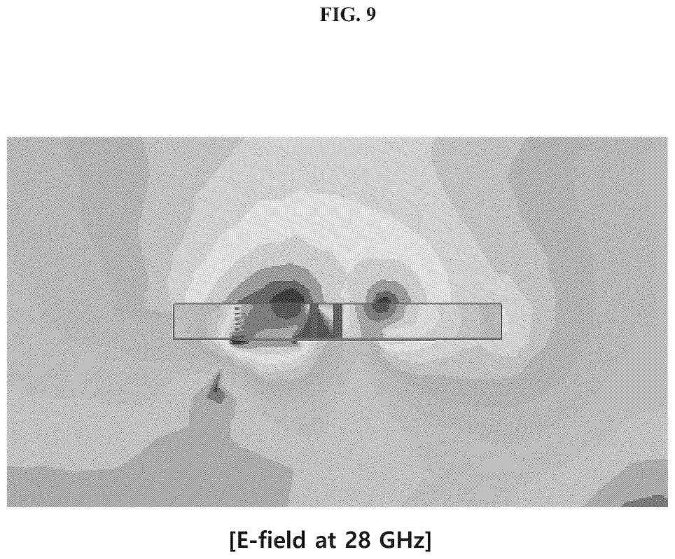

In this regard, FIG. 7 illustrates reflection coefficients measured based on a common ground plane in FIG. 6, FIG. 8 illustrates a gain measured at a frequency of 28 GHz for broadside radiation of a radiator module according to an embodiment of the present disclosure, and FIG. 9 illustrates an electric field distribution at a frequency of 28 GHz for broadside radiation of a radiator module according to an embodiment of the present disclosure. As illustrated in FIG. 7, good S parameters were measured in both the broadside radiation and the end-fire radiation, and good broadside radiation performance was identified, as shown in the gain measured at the frequency of 28 GHz for the broadside radiation of the radiator module according to an embodiment of the present disclosure in FIG. 8 and the electric field distribution at the frequency of 28 GHz for the broadside radiation of the radiator module according to an embodiment of the present disclosure in FIG. 9.

That is, the radiator module that performs the broadside radiation and the end-fire radiation according to an embodiment of the present disclosure may implement the radiation in different directions depending on a feeding applied via the complementary ground plane structure. When the feeding is made via a broadside port, the ground plane having the same effect as that of the existing patch radiator 300 may be formed, and when the feeding is made via an end-fire port, the V-pol end-fire radiation via the Image theory may be implemented.

In this regard, according to an aspect of the present disclosure, the at least one port may include at least one vertical probe port. In addition, according to an aspect, the at least one port may include the broadside port 410 for the broadside radiation and the end-fire port 420 for the end-fire radiation. However, the technical idea of the present disclosure may not be limited thereto, and the broadside radiation and/or the end-fire radiation may be selectively performed with the one port.

As a non-limiting example, according to an aspect, the broadside port 410 may be disposed to be spaced apart from a center line between the first directional edge and the second directional edge of the common ground plane 210, and may be disposed at a location corresponding to a center line between the third directional edge and the fourth directional edge of the common ground plane 210.

On the other hand, according to an aspect, the end-fire port 420 may be disposed at a location corresponding to the center line between the first directional edge and the second directional edge of the common ground plane 210, and may be disposed to be spaced apart from the center line between the third directional edge and the fourth directional edge of the common ground plane 210.

However, it should be noted that the arrangement of the ports illustrated in the drawing is exemplary and the technical idea of the present disclosure is not limited thereto.

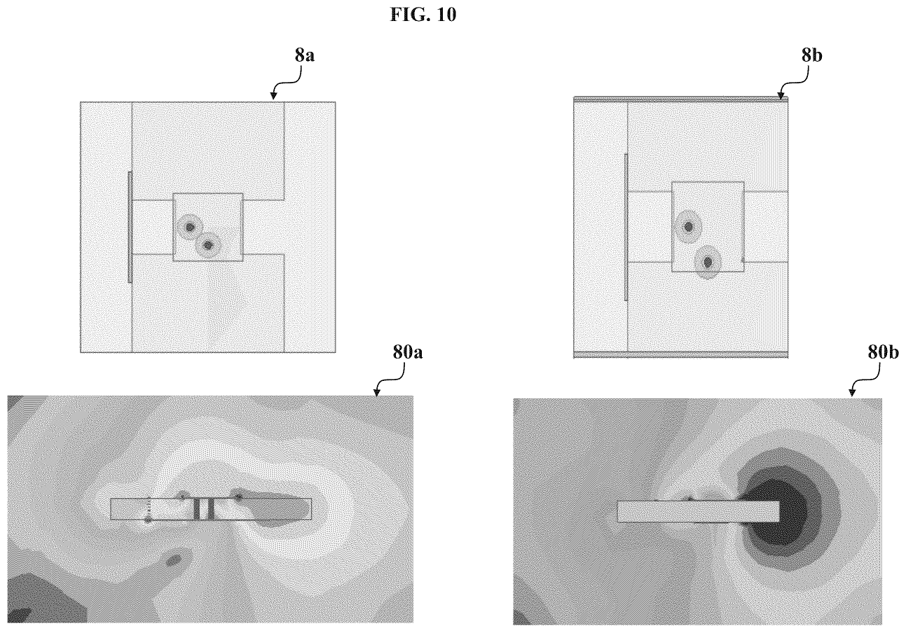

FIG. 10 illustrates a change in performance of end-fire radiation based on dielectric cutting according to an aspect. As illustrated in FIG. 10, according to an aspect of the present disclosure, when the common ground plane is formed (8a) on a top surface of the dielectric layer with margins at first and second directional sides of the dielectric layer, because of such a complementary ground plane, distortion of an end-fire radiation pattern particularly occurs and the front back ratio (FBR) increases (80a). In relation thereto, it was seen that the front back ratio (FBR) of the end-fire radiation is improved (80b) by cutting (8b) one side of the dielectric layer, more specifically, a portion of the dielectric layer extending from an area corresponding to the first directional edge of the common ground plane 210 to an area corresponding to a first directional edge of the dielectric layer 100.

In relation thereto, according to an aspect of the present disclosure, the first directional edge of the common ground plane 210 and the first directional edge of the dielectric layer 100 may coincide with each other. For example, the dielectric layer 100 may be cut in the area of the dielectric layer 100 corresponding to the first directional edge of the common ground plane 210, but the formation process is not limited thereto. On the other hand, according to an aspect, the edge of the dielectric layer in the second direction opposite to the first direction may be disposed so as to be spaced apart from the second directional edge of the common ground plane in the second direction as illustrated in FIGS. 1 to 2 and 6, but the present disclosure may not be limited thereto.

As described above, the radiator module that performs the broadside radiation and the end-fire radiation according to an embodiment of the present disclosure may ameliorate the distorted radiation pattern and the FBR with the dielectric structure modification, via the complementary ground plane structure.

The radiator module that performs the broadside radiation and the end-fire radiation according to an embodiment of the present disclosure may be implemented using a two-dimensional stacking technology, but the present disclosure may not be limited thereto. According to an aspect, the radiator module may be manufactured by selecting one of various processes and materials such as a PCB, an LTCC, and a glass. For example, the antenna may be implemented to have an overall height of 0.07λ (based on 28 GHz), but the present disclosure may not be limited thereto. In this design, the broadside radiation and the end-fire radiation with the vertical polarization may be simultaneously implemented (low profile). In addition, as a non-limiting example, the antenna device that performs the broadside radiation and the end-fire radiation according to an embodiment of the present disclosure may be designed to have, for example, a length of 21.6 mm, a width of 5.6 mm, and a height of 0.76 mm, but the present disclosure may not be limited thereto.

In one example, according to an aspect, an easy surface mount of a communication chip may be implemented by setting a coaxial-type ground signal ground (GSG) pad on a top surface. For example, the antenna may be fed in a form of vertical probe via a vertical interconnection from the GSG Pad.

In addition, according to an aspect, the radiator module that performs the broadside radiation and the end-fire radiation according to an aspect of the present disclosure may be implemented based on, for example, the low-temperature co-fired ceramics (LTCC) process. An exemplary radiator module may be composed of eight metal layers of L1 to L8 and a plurality of dielectric layers interposed therebetween. For example, the LTCC may have a dielectric constant of 5.9 and a loss tangent of 0.002, and a total of seven LTCC layers may be used with a thickness of 0.1 mm. In addition, silver may be used as the metal layer, and in this case, a total of 8 metal layers may be used with a thickness of 10 μm. A first metal layer may be used as a feeding structure, and the antenna may be implemented in an eighth metal layer.

### Antenna Device

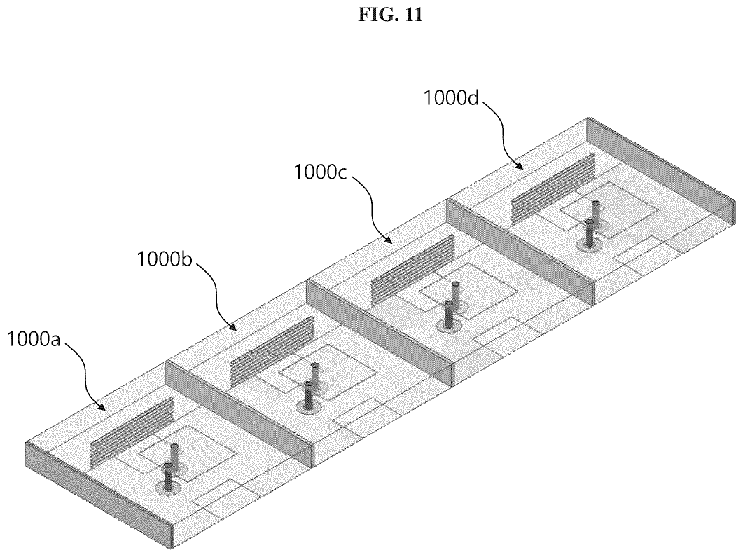

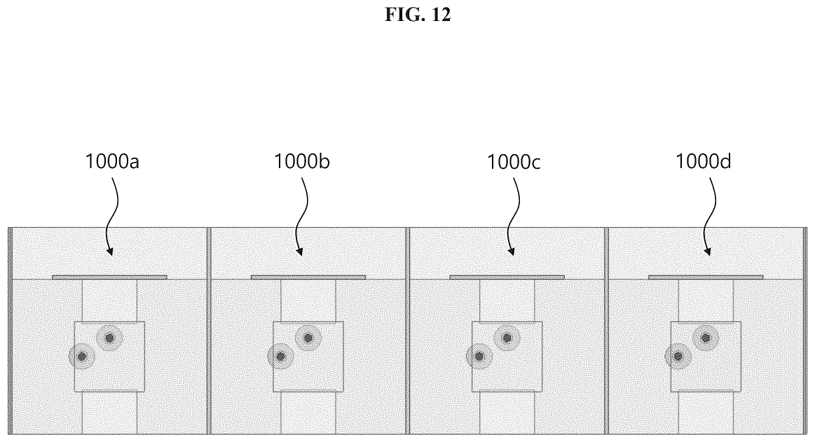

FIG. 11 is a perspective view of an antenna device that performs broadside radiation and end-fire radiation according to an embodiment of the present disclosure, and FIG. 12 is a top view of an antenna device in FIG. 11. As illustrated in FIGS. 11 to 12, the antenna device according to an embodiment of the present disclosure includes a radiator array including a plurality of radiator modules 1000a, 1000b, 1000c, and 1000d, and a control circuit that applies signals to the plurality of radiator modules. Here, for example, the control circuit may be an RFIC, but the present disclosure may not be limited thereto.

Each of the plurality of radiator modules may include a dielectric layer, a ground layer disposed on the dielectric layer and including a common ground plane for both broadside radiation and end-fire radiation, a patch radiator disposed on the ground layer so as to be spaced apart from the ground layer by a predetermined length, and at least one port disposed between the common ground plane and the patch radiator. In addition, the configuration of the radiator module described above herein may be at least partially employed.

For example, the radiator modules that perform the broadside radiation and the end-fire radiation according to an embodiment of the present disclosure may constitute the radiator array. Here, the control circuit may perform broadside directional beamforming by controlling each of the plurality of radiator modules to perform the broadside radiation, or may perform end-fire directional beamforming by controlling each of the plurality of radiator modules to perform the end-fire radiation.

Accordingly, the number of conventional single-directional AiPs may be reduced, and at the same time, beamforming coverage may be improved. In addition, the antenna device may be implemented in a small size, which is advantageous for mounting in a current mobile device.

In relation thereto, according to an aspect of the present disclosure, the phased array antenna device may be composed of four radiator modules according to an embodiment of the present disclosure. Here, a total of eight ports may be used, including four broadside ports and four end-fire ports, but the present disclosure may not be limited thereto. Further, as a non-limiting example, the radiator modules may be arranged at a spacing of 5.4 mm, similar to a half wavelength of 28 GHz.

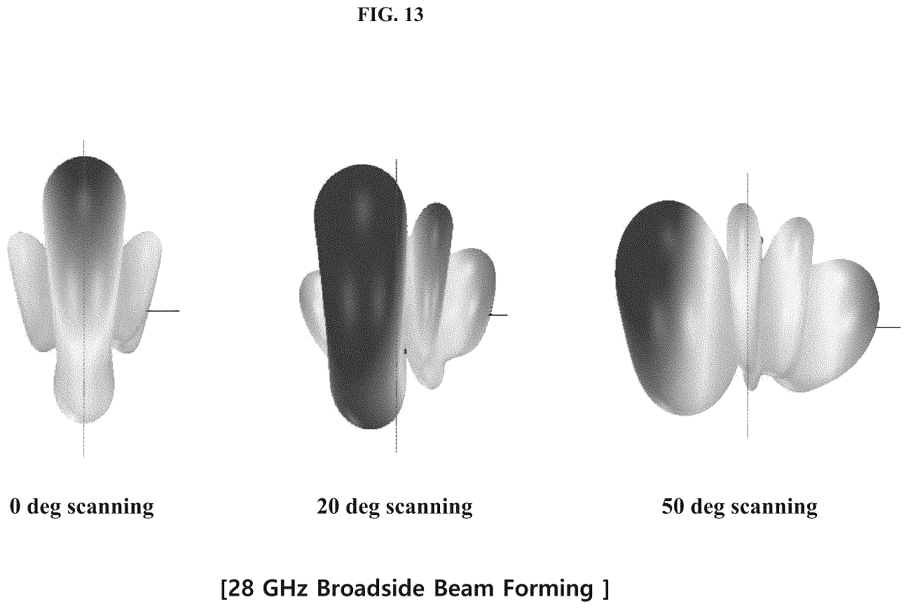

FIG. 13 illustrates a beamforming performance in broadside radiation at a frequency of 28 GHz of an antenna device in FIG. 11. As illustrated in FIG. 13, it was identified that the antenna device according to an aspect of the present disclosure has a realized gain of 10.8 dBi and a beam steering performance in a range of −50 to 50 deg, based on the broadside radiation.

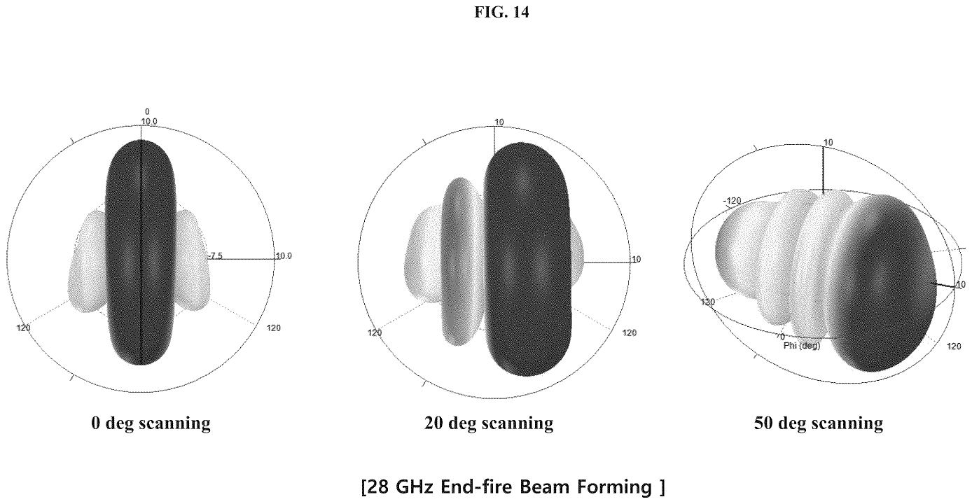

FIG. 14 illustrates a beamforming performance in end-fire radiation at a frequency of 28 GHz of an antenna device in FIG. 11. As illustrated in FIG. 14, it was identified that the antenna device according to an aspect of the present disclosure has a realized gain of 9.6 dBi and a beam steering performance in a range of −50 to 50 deg, based on the end-fire radiation.

That is, the antenna device according to an aspect of the present disclosure may simultaneously perform the broadside radiation and the V-pol end-fire radiation using only one type of radiator, and may perform the beamforming in both the broadside and V-pol end-fire directions using only the single structure without using the active element.

Although the description has been made with reference to the drawings and the embodiments, it should be understood that the scope of the present disclosure is not limited thereto. Those skilled in the art will appreciate that various modifications and changes may be made to the present disclosure without departing from the spirit and scope of the present disclosure as defined in the following claims.

The present disclosure has been described based on a series of functional blocks, but is not limited to the above-described embodiments and the accompanying drawings, and it will be obvious to a person skilled in the art to which the present disclosure belongs that various substitutions, modifications, and changes may be made within the scope not departing from the technical spirit of the present disclosure.

Combinations of the above-described embodiments are not limited to the above-described embodiments, and various types of combinations as well as the above-described embodiments may be provided based on implementation and/or necessity.

In the above-described embodiments, the methods have been described based on a flowchart as a series of steps or blocks, but the present disclosure may not be limited to an order of the steps, and some steps may occur in a different order or simultaneously with other steps as described above. In addition, those of ordinary skill in the art will appreciate that the steps illustrated in the flowchart are not exclusive, other steps may be included, or one or more steps in the flowchart may be deleted without affecting the scope of the present disclosure.

The foregoing embodiment includes examples of various aspects. While all possible combinations for representing the various aspects are not able to be described, those of ordinary skill in the art will be able to recognize that other combinations are available. Accordingly, the present disclosure will be said to include all other replacements, modifications, and changes that fall within the scope of the following claims.

What is claimed is:

1. A radiator module for performing broadside radiation and end-fire radiation, the radiator module comprising:
a dielectric layer;
a ground layer disposed on the dielectric layer and having a common ground plane for both the broadside radiation and the end-fire radiation;
a patch radiator disposed on the ground layer so as to be spaced apart from the ground layer by a predetermined length; and
at least one port disposed between the common ground plane and the patch radiator.

2. The radiator module of claim 1, wherein the common ground plane includes a first notch area defined in at least a portion of an edge of the common ground plane in a first direction,
wherein the first notch area includes an area extending from a location of the common ground plane corresponding to an edge of the patch radiator in the first direction to the edge of the common ground plane in the first direction.

3. The radiator module of claim 2, wherein the patch radiator is configured to perform the end-fire radiation in the first direction as the first notch area is included.

4. The radiator module of claim 3, wherein a signal transmitted and received via the end-fire radiation is a vertically polarized signal.

5. The radiator module of claim 2, wherein the common ground plane includes a second notch area defined in at least a portion of an edge of the common ground plane in a second direction opposite to the first direction,
wherein the second notch area includes an area extending from a location of the common ground plane corresponding to an edge of the patch radiator in the second direction to the edge of the common ground plane in the second direction.

6. The radiator module of claim 5, wherein the patch radiator is configured to perform the end-fire radiation in the second direction as the second notch area is included.

7. The radiator module of claim 5, further comprising a reflector disposed to be directed in the second direction of the common ground plane and extending in a height direction of the radiator module.

8. The radiator module of claim 7, wherein the reflector is configured to reflect a second directional end-fire radiation signal based on the second notch area.

9. The radiator module of claim 5, wherein the common ground plane further includes a first broadside ground area defined in an area extending from a location of the common ground plane corresponding to an edge of the patch radiator in a third direction to an edge of the common ground plane in the third direction.

10. The radiator module of claim 9, wherein the common ground plane further includes a second broadside ground area defined in an area extending from a location of the common ground plane corresponding to an edge of the patch radiator in a fourth direction opposite to the third direction to an edge of the common ground plane in the fourth direction.

11. The radiator module of claim 10, wherein the common ground plane allows the patch radiator to perform both the broadside radiation and the end-fire radiation as the first notch area, the second notch area, the first broadside ground area, and the second broadside ground area are included.

12. The radiator module of claim 1, wherein the at least one port includes at least one vertical probe port.

13. The radiator module of claim 1, wherein the at least one port includes:
a broadside port for the broadside radiation; and
an end-fire port for the end-fire radiation.

14. The radiator module of claim 13, wherein the broadside port is disposed to be spaced apart from a center line between an edge in a first direction and an edge in a second direction of the common ground plane, and is disposed at a location corresponding to a center line between an edge in a third direction and an edge in a fourth direction of the common ground plane.

15. The radiator module of claim 13, wherein the end-fire port is disposed at a location corresponding to a center line between an edge in a first direction and an edge in a second direction of the common ground plane, and is disposed to be spaced apart from a center line between an edge in a third direction and an edge in a fourth direction of the common ground plane.

16. The radiator module of claim 2, wherein the edge of the common ground plane in the first direction and an edge of the dielectric layer in the first direction coincide with each other.

17. The radiator module of claim 16, wherein an edge of the dielectric layer in a second direction opposite to the first direction is disposed to be spaced apart in the second direction from an edge of the common ground plane in the second direction.

18. An antenna device for performing broadside radiation and end-fire radiation, the antenna device comprising:
a radiator array including a plurality of radiator modules; and
a control circuit configured to apply signals to the plurality of radiator modules,
wherein each of the plurality of radiator modules includes:
a dielectric layer;
a ground layer disposed on the dielectric layer and having a common ground plane for both the broadside radiation and the end-fire radiation;
a patch radiator disposed on the ground layer so as to be spaced apart from the ground layer by a predetermined length; and
at least one port disposed between the common ground plane and the patch radiator.

19. The antenna device of claim 18, wherein the control circuit is configured to perform broadside directional beamforming by controlling each of the plurality of radiator modules to perform the broadside radiation.

20. The antenna device of claim 18, wherein the control circuit is configured to perform end-fire directional beamforming by controlling each of the plurality of radiator modules to perform the end-fire radiation.
